(19) United States
(12) Patent Application Publication
(10) Pub. No.: US 2021/0178487 A1
(43) Pub. Date: Jun. 17, 2021

(54) 3D-Metal-Printing Method and Arrangement Therefor

(71) Applicants: Value & Intellectual Properties Management GMBH, Bruckmühl (DE); AIM Sweden AB, Frösön (SE); Additive Innovation and Research Sweden AB, Vikingabacken 10 (SE)

(72) Inventors: Kai K.O. Bär, Bad Aibling (DE); Karl Neulinger, St. Polten (DE); Lars-Erik Rannar, As (DE); Andrey Koptyug, Ostersund (DE)

(73) Assignee: Value & Intellectual Properties Management GMBH, Bruckmühl (DE)

(21) Appl. No.: 17/268,794

(22) PCT Filed: Aug. 9, 2019
(86) PCT No.: PCT/DE2019/100723

§ 371 Date: Feb. 16, 2021

(30) Foreign Application Priority Data
Aug. 16, 2018 (DE) I0 2018 120 015.3

(51) Int. Cl. B22F 12/41; B33Y 10/00; B33Y 30/00; B22F 10/28; B22F 10/64; B33Y 40/20; H05B 3/00; B23K 15/00; H05B 3/42; G02B 19/00

(52) U.S. Cl. CPC B22F 12/41; B33Y 10/00; B33Y 30/00; B22F 10/28; B22F 10/64; G02B 19/0019; H05B 3/0061; B23K 15/0086; H05B 3/42; B23K 15/002; G02B 19/009; B33Y 40/20

(57) ABSTRACT

3D metal printing process for producing a spatial metal product essentially from a metal powder or metal filaments as starting material, the powder or the filaments being built up layer by layer by applying layers of starting material to a respective previously produced layer and selective local heating of predetermined points of the layer above a sintering or melting temperature of the powder and sintering or fusing of the molten points with the underlying layer and optional annealing of the points. wherein at least the respective newly applied starting material layer is pre-heated and/or post-treated for thermal stress compensation following the local heating of the predetermined points by means of two-dimensional irradiation of IR radiation in such a way that a radiation spot with an area of at least 5 mm2, more particularly of more than 20 mm2 and even more particularly of more than 100 mm2, is formed on the surface of the starting material layer.

The invention relates to a 3D metal printing process, in particular one based on electron beams, for producing a spatial metal product essentially from a metal powder or metal filaments, wherein the metal product is built up layer by layer by applying layers of starting material to a respective previously produced layer and selectively locally heating predetermined points of the layer above a sintering or melting temperature and sintering or fusing the melted points with the underlying layer at the corresponding points, and wherein a pre-heating of the existing partial metal product and/or a thermal post-treatment is carried out. It further relates to an arrangement for carrying out such a process.

In recent years, a variety of processes have been developed for the layer-by-layer construction of spatial metal products, which are summarised under the terms “additive manufacturing” or “3D printing”. These processes are partly based on melting and solidification steps and then include selective local heating of previously applied layers of starting material, which is also referred to here as “point-by-point” or “point-scanning” heating. For the production of metal products, in particular from relatively high-melting metals such as titanium, a coordinate-controlled laser beam or electron beam that can be moved over the starting material layers is usually used.

In practice, laser beam processes (LMB) currently dominate, which have to use a high-energy laser beam due to the high temperatures required for local melting of the top layer of the product under construction. Due to the resulting softening and thermal stresses in the top layer, complex support structures are sometimes required, depending on the product geometry, which have to be removed from the finished product at great expense. The high temperatures also lead to undesirable “caking” of the starting material powder or the starting material filaments outside the contour of the product to be manufactured. Removing such caked powder or filament portions from the finished product also requires effort and often leaves an undesirably uneven product surface. Moreover, caked starting material cannot be easily recovered and used for the manufacture of further products, so that the utilisation of the starting material in such processes leaves much to be desired.

As a rule, the finished products must be subjected to subsequent thermal treatment (annealing) to relieve stress due to the punctual thermal stresses that occurred during the manufacturing process. Depending on the product size and geometry, this takes a considerable amount of time and thus seriously reduces the productivity of laser-based processes.

Electron beam processes (EBM processes) require a great deal of equipment and are currently only economically viable for products with relatively small dimensions and are therefore still relatively uncommon. In these processes, the top layer of the starting material is usually pre-heated before local melting by means of a “stochastic” scanning of the entire surface with the electron beam, which further increases the equipment and control costs and also considerably extends the manufacturing time of the product. On the other hand, thermal stresses are much less pronounced here, and the measures mentioned above to control them or eliminate their consequences are largely unnecessary.

The invention is based on the object of providing an improved process of the type described and an arrangement for carrying it out, with which high productivity, economical material utilisation and moderate energy consumption and thus overall reduced product costs can be achieved while at the same time meeting high quality requirements.

This task is solved in its process aspect by a 3D metal printing process with the features of claim 1 and in its device aspect by an arrangement with the features of claim 9. Useful further embodiments of the invention are the subject of the dependent claims.

It is an idea of the present invention to carry out a pre-heating before the local, “point-by-point” melting of newly applied material layers and/or a parallel supporting heating during the point-by-point melting only in the areas (layers) of the resulting metal product that are actually to be processed.

According to a relatively independent aspect of the invention, a thermal post-treatment is carried out immediately after the local melting, equally area-wise or layer-wise.

A further idea of the invention is to carry out the preheating or postheating not spot-wise as in the established electron beam methods, but over a relatively large area (as compared to the spot diameter of an electron beam). In particular, the pre-heating should be carried out over an area of at least 5 mm2, more specifically more than 20 mm2 and even more specifically more than 100 mm2. Various contours of the radiation spot can be realised, but from a practical point of view it will usually be rectangular. With a rectangular radiation spot, a scanning preheating or postheating of the entire surface of the respective starting material layer can be realised reliably and with relatively little control effort and a short treatment time.

Very cheaply available infrared (IR) radiation is used as the energy source, and this explicitly includes the use of near IR radiation, i.e. that with a radiation density maximum in the wavelength range between 0.8 and 1.5 μm.

In practically significant embodiments, the metal powder used is an aluminium, stainless steel or titanium powder or also refractory metal powder or powder made from alloys with these metals. A combination with ceramic or other non-metallic powder is also possible. In principle, the process can also be carried out with starting materials in filament form or as granules.

In an embodiment, the IR radiation is irradiated sequentially in sections into partial sections of the total surface of the respective starting material layer, whereby the selective local heating above the sintering or melting temperature is carried out in each case for predetermined points within a pre-heated partial portion. The pre-heating or stress-reducing two-dimensional post-heating thus “wanders” over the surface of the respective starting material layer to be treated, in particular in preparation for and accompanying the local heating above the sintering or melting temperature.

In a currently preferred embodiment, a strip-shaped radiation spot, i.e. in the form of a narrow rectangle, is created on the surface of the metal product being built up, which extends over the entire width or length of the product. This “band” is then moved over the surface perpendicular to its direction of extension, so that the entire surface of the last layer of starting material is successively preheated.

The geometry of the radiation spot, especially the width of a band-shaped radiation spot, is adjusted by selecting a reflector with a suitable geometry in coordination with the parameters of the IR emitter or NIR emitter used in such a way that the power density achieved meets the process requirements. An important aspect here is that the passing over of the entire surface to be preheated with the radiation spot is coordinated with the subsequent selective local (punctual) heating of the material for sintering and melting. The entire process should take as short time as possible in the interest of a high process economy. However, if the application of IR radiation serves the purpose of post-heating for the purpose of stress reduction or annealing or similar, the physical conditions must be primarily taken into account for the effect to be achieved.

As in conventional processes, in a further embodiment the selective local heating of predetermined points for sintering or melting and for tempering is effected by scanning the starting material layer with an electron beam. It makes sense to synchronise the selective exposure of the preheated starting material layer with the electron beam to the above-mentioned area-wise and especially strip-shaped exposure to the radiation serving for preheating. In particular, the electron beam should hit optimally preheated (and not already somewhat cooled) points of the starting material layer. The control of the electron beam deflection must therefore be linked to the control of the IR irradiation device.

In practical embodiments of the process, the power density of the IR radiation irradiated in a “static” or “travelling” manner on the surface of the uppermost layer of starting material is above 1 MW/m2, and the radiation of at least one halogen radiator, in particular a plurality of halogen radiators, with a radiator temperature of up to 3200 K, in particular in the range from 2900 K to 3200 K, is used as the near IR radiation.

The preheating according to the invention enables the application of considerably thicker material layers than with the previous EBM processes, namely, from the current point of view, a thickness of more than 150 μm, more specifically of more than 300 μm and even more specifically of more than 500 μm. The invention ensures that such layers of starting material are completely heated and, if necessary, that sufficient heat conduction into an underlying layer contributes to better bonding of the successive layers or to their improved properties.

The extent to which high-quality products can be built up from such thick material layers with high productivity will depend, in the case of the electrode-beam-based processes, on the possibility of using powerful electron beam sources and associated deflection and focusing devices. In any case, the process proposed here creates far-reaching prerequisites for this.

In further embodiments of the proposed method, it is proposed that a preheating temperature selected as a function of the melting temperature and further parameters of the metal or alloy to be processed is set, in particular in the range between 600 and 1200° C., and is controlled in particular by a time and/or radiation density control of the areal irradiation of the IR radiation. For example, a temperature setting in the range between 600 and 800° C. appears for the processing of titanium alloys and in the range between 1000 and 1200° C. for nickel-based alloys or so-called super alloys.

For the optimisation of the overall process, it is important, especially in electron beam-based processes, to maintain a material-specific temperature range (“window”) of the respective processed layer for a predetermined time. The effect of the two-dimensional IR radiation vs. the spot-like electron beam should therefore preferably be adjusted on the control side to ensure such a temperature/time window.

Overall, the proposed solution enables a significant reduction in process times, both in terms of layers and in relation to an overall product, in the order of 50% or more.

Advantageous embodiments of the proposed arrangement are mostly apparent to the person skilled in the art on the basis of the process aspects explained above, so that detailed explanations of the apparatus are largely dispensed with. However, the following aspects of the device are pointed out:

While the structure of the overall arrangement largely corresponds to that of known 3D printers whose function is based on the sequential local melting of metal powders or filaments applied in layers, a special feature is the design of the apparatus for the two-dimensional heating of the respective uppermost starting material layer, in the sense of a pre-heating before the local melting and/or of a thermal post-treatment for stress compensation immediately after the melting.

This apparatus has an IR irradiation device for irradiating IR radiation with high power density onto a predetermined area of at least 5 mm2, more particularly of more than 20 mm2, still more particularly of more than 100 mm2 in the plane of the work table. From the present perspective, further development of EBM technology incorporating the present invention may also consider simultaneous preheating of substantially larger surface areas, particularly if the technology is made applicable to significantly larger products than those produced thereby.

The phrase “in the plane of the worktable” is to be understood in a general sense and does not necessarily mean that the IR irradiation device is placed vertically above the worktable, nor that its lateral extension coincides with that of the worktable. With suitable reflector geometry, the IR irradiation device can have a smaller footprint than the worktable and also be positioned obliquely above it or even laterally from it.

When the present invention is used in the EBM process, which is carried out in high vacuum, the NIR irradiation device must be placed and operated in particular in the vacuum chamber, and it must be positioned in such a way as to prevent any interference with the scanning of the product surface by the electron beam.

In a practically proven embodiment, the special NIR irradiation device has at least one rod-shaped (linear) halogen radiator, in particular a plurality of halogen radiators, with an associated reflector such that the radiation of the or each infrared radiator is concentrated in the direction of the work table. In other embodiments, however, the IR irradiation device can also comprise an array of high-power NIR laser diodes, and in such an embodiment it may also be possible to largely dispense with special reflectors.

In a further embodiment, the plurality of halogen radiators with associated reflector is mounted above the work table in a position-controlled manner in at least one axial direction of an XY plane. This design serves to implement a process control in which the pre-heating is only carried out for a specific partial surface section of the metal product being produced and this area “moves” over the surface to be processed.

Alternatively, it can be provided that the plurality of halogen spotlights with associated reflector is mounted stationary or at most height-adjustable above the work table.

In a manner known per se, the means for effecting selective local heating of predetermined points of a pre-applied starting material layer comprise an electron beam gun with associated deflection devices for beam positioning according to the desired product geometry.

The invention provides, at least in certain embodiments, several significant advantages over prior art methods.

Compared to heat chamber solutions, heating essentially only the last layer of starting material immediately before local sintering or fusing enables large workpiece volumes to be heated, and is thus fundamentally energy-saving and reduces the thermal load on the overall device.

Furthermore, the procedure according to the invention reduces the permanent exposure of programmed non-sintered or fused areas of feedstock layers processed in previous process steps to relatively high temperatures, thus reducing unintended softening and deterioration of the non-sintered powder in those layers, which can significantly improve the efficiency of recovering recyclable metal powder after a product is finished.

Since, according to the invention, larger temperature differences can be set between the “points” of the powder or filament layers that are to be fused and those that are not, such undesirable softening effects are significantly reduced, if not completely eliminated. Whereas in conventional processes it is often necessary to expensively clean the finished product of such adhering softening portions, such cleaning steps can be largely dispensed with when using the invention. In addition, screening or other preparation of the raw material returned from the process can be largely dispensed with.

Compared to known EBM processes, according to the findings of the inventors, the invention allows an improved drying of the starting material as a basis for a qualitatively improved fusion or sintering process, and there also appears to be a positive influence on the conductivity of the metal powder with regard to the subsequent selective exposure to the electron beam, in particular in the sense of an acceleration of the desired changes compared to electron beam preheating.

According to the inventors' findings, the heating of larger areas of the last applied starting material layer can also be combined with a post-heating of the previously applied and selectively fused or sintered material layer in the sense of annealing. This offers the possibility of a structural quality improvement of the metal product produced.

Especially in comparison to laser-based processes, in which support structures are provided on the product, the invention also offers the advantages of significant time and cost savings due to the extensive elimination of such support structures and thus also the elimination of the post-processing steps for their removal. Equally important is the time saved and the resulting productivity advantage due to the elimination or at least the shortening of the overall thermal post-processing of the finished product for stress relief.

Advantages and usefulness of the invention can also be seen from the following description of an example of an embodiment based on the single FIGURE.

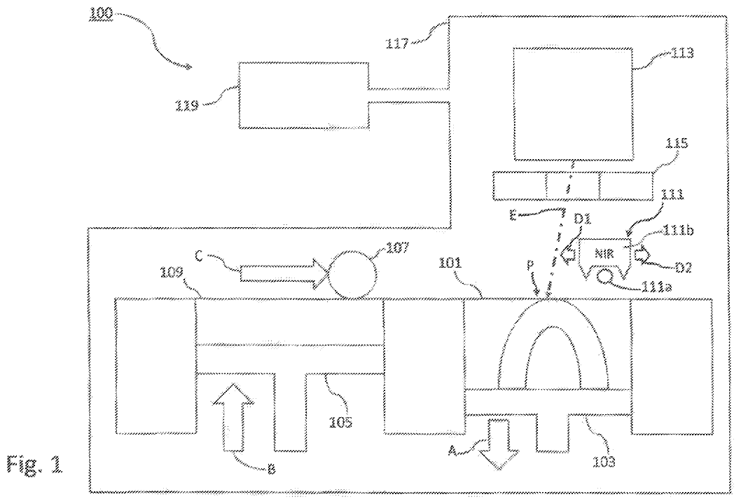

FIG. 1 shows a sketch of an arrangement 100 for additive manufacturing of a spatial metal product P (not yet shown in full here), which is formed from a metal powder bed 101 by applying metal powder layer by layer and locally heating the individual layers by scanning.

The arrangement comprises a work table 103 on which the metal powder bed 101 is applied layer by layer and the metal product P is formed. As symbolised by the arrow A, the work table 103 is vertically movable in order to keep the surface of the metal powder bed 101 at the same height level despite its increasing height as the layer application progresses.

A powder application device for feeding metal powder into the actual working area comprises a punch 105, which can be moved vertically in the direction of arrow B, i.e. in the opposite direction to arrow A, and a powder application blade 107, which can be moved in the direction of arrow C and displaces metal powder 109, which is accommodated on the punch 105 as a supply, in each case in individual layers of predetermined thickness into the working area (i.e. in the FIGURE to the right into the powder bed 101). It should be noted that the means for successively applying layers of powder to the work table the metal powder bed 101 formed there are shown in the FIGURE only by way of example and symbolically; the actual execution of this work step in the context of the realisation of the invention can be carried out according to established techniques.

An NIR radiation source 111, which in the example constitutes of a single halogen lamp 111a and an associated reflector 111b, is positioned above the working area. The NIR radiation source 111 can be moved laterally back and forth over the powder bed 101, as symbolised by the arrows D1 and D2, and serves to preheat the respectively irradiated sections of the powder bed to a temperature below a sintering or melting temperature of the metal powder. Optionally, it is also used for thermal annealing of a locally melted layer immediately beforehand, which can be done, for example, by “moving back” the NIR radiation source in the direction of arrow D2, if the radiation source has been moved over the surface of the powder bed 101 in the direction of arrow D1 for pre-heating. The NIR radiation source 111 can also comprise several halogen lamps with a reflector that is then shaped accordingly.

An electron beam tube 113 with associated coordinate-controlled deflection unit 115 is arranged above the working area. The deflection unit 115 directs an electron beam E generated by the electron beam tube 113 to any points on the surface of the preheated powder bed 101, which are predetermined by production drawings of the metal product P with regard to its individual layers. The electron beam heats the powder bed 101, which is preheated on its surface by the NIR radiation, above the sintering or melting temperature at the impact points predetermined according to the product geometry. This causes sintering with the respective underlying layer at those points and thus the next layer of the metal product P is formed. In the usual manner, the metal powder 109 remains in the powder state at those points where it has not been heated above the sintering or melting temperature and falls off the metal product P after removal from the work table or can be washed out of it.

By means of a (not shown) power operating current control of the electron tube 113, the power of the electron beam E and thus the achievable temperature at the point of impact can be controlled almost without delay. This enables, among other things, the precise T-controlled execution of sintering or melting steps on the one hand and subsequent annealing steps of the applied metal layer on the other hand.

The entire arrangement is housed in a vacuum chamber 117, which is associated with a vacuum generator 119 for generating a high vacuum in the vacuum chamber during the manufacturing process of a product.

Moreover, the invention can also be implemented in a variety of variations of the example shown here and aspects of the invention highlighted above.

4. 3D metal printing process according to claim 1, wherein the radiation of at least one halogen radiator, in particular a plurality of halogen radiators, with a radiator temperature in particular in the range from 2900 K to 3200 K, is used as IR radiation.

5. 3D metal printing process according to claim 1, wherein more than one rod-shaped IR emitter, in particular halogen emitter, with associated reflector is used to produce a narrow rectangular radiation spot.

6. 3D metal printing process according to claim 1, wherein the selective local heating of predetermined points is effected by scanning the starting material layer with an electron beam.

7. 3D metal printing process according to claim 1, wherein each deposited source material layer has a thickness of at least 150 □m, more particularly of more than 300 □m and still more particularly of more than 500 □m, and is heated through its full thickness by the IR radiation.

8. A system for performing a 3D metal printing process for producing a spatial metal product essentially from a metal powder or metal filaments as a starting material, comprising:
a work table as a base for building up the spatial metal product layer by layer,
a powder application device for sequentially applying starting material layers of a metal powder or starting material filaments in an area of the work table,
a surface heating device for surface heating of each new starting material layer, and for pre-heating or thermal post-treatment, the surface heating device comprising an IR irradiation device for generating a radiation spot having an area of at least 5 mm2, more particularly of more than 20 mm2 and even more particularly of more than 100 mm2, wherein the power density of the IR radiation irradiated over the surface of the starting material layer is above 1 MW/m2, and
apparatus for effecting selective local heating of predetermined points of the new starting material layer above a sintering or melting temperature of the metal powder.

9. The system according to claim 8, wherein the apparatus for effecting selective local heating of predetermined points of a pre-applied layer of starting material comprise an electron beam generator for point-by-point irradiation of electron radiation to the predetermined points, and the apparatus further comprises a vacuum chamber subjected to high vacuum.

10. The system according to claim 8, wherein the IR irradiation device comprises at least one IR-irradiator, in particular halogen irradiator, with a reflector associated and formed in such a way that the radiation of each infrared irradiator is concentrated in the direction of the work table and the radiation spot has an area of at least 5 mm2, more particularly of more than 20 mm2 and even more particularly of more than 100 mm2 is formed on the last layer of starting material.

11. The system according to claim 10, wherein the IR irradiator or a plurality of IR irradiators with associated reflector is movably mounted above the work table in at least one axial direction of an XY plane.

12. The system according to claim 10 or 11, wherein the halogen radiator(s) operate with a radiator temperature in the range of 2900 K to 3200 K.

13. The system according to claim 10, wherein the IR irradiation device is equipped with at least one rod-shaped IR radiator, in particular halogen radiator, the length of which corresponds to at least one dimension of the metal product to be produced, and comprises a device for moving the IR radiator in exactly one axial direction of the XY plane.

14. The system according to claim 9, further comprising a heating control device which is connected via control outputs to the surface heating device and the apparatus for effecting selective local heating and controls both in accordance with a heating control program such that a temperature in a predetermined temperature range is maintained in the new starting material layer for a predetermined period of time.
